(19) United States
(12) Patent Application Publication
(10) Pub. No.: US 2022/0011027 A1
(43) Pub. Date: Jan. 13, 2022

(54) COOLING PIPE SYSTEM

(71) Applicant: Wuyi University, Jiangmen City (CN)

(72) Inventor: Min WU, Jiangmen City (CN)

(21) Appl. No.: 17/320,476

(22) Filed: May 14, 2021

(30) Foreign Application Priority Data
Jul. 9, 2020 (CN) 2020106562012

(51) Int. Cl. F25B 15/06

(52) U.S. Cl. CPC F25B 15/06

(57) ABSTRACT

A lithium bromide refrigeration system is disclosed, including: a generator having a liquid storage cavity and connected to a heating apparatus; an absorber having an inner cavity; an evaporator above the absorber, the evaporator including an evaporation chamber communicated with the inner cavity; a vacuum pump connected to the absorber, the vacuum pump being configured for vacuumizing the inner cavity. The generator is provided with a spraying pipe communicated with the liquid storage cavity, an outlet of the spraying pipe is located at an upper part of the inner cavity, the absorber is provided with a liquid extraction pipe communicated with the inner cavity, and an outlet of the liquid extraction pipe is located at an upper part of the liquid storage cavity. The system further includes a heat exchanger for exchanging heat between the spraying pipe and the liquid extraction pipe.

### CROSS-REFERENCE TO RELATED APPLICATIONS

This application is based on and claims the benefit of priority from Chinese Patent Application No. 2020106562012, filed on 9 Jul. 2020, the entirety of which is incorporated by reference herein.

### TECHNICAL FIELD

The present disclosure relates to the technical field of refrigeration, and in particular, to an open-type lithium bromide refrigeration system.

### BACKGROUND

Lithium bromide refrigeration technology relates to using lithium bromide aqueous solution at different temperatures to absorb and release water vapor to implement refrigeration, which uses an external heat source for implementing refrigeration. Since the lithium bromide refrigeration technology has many unique advantages, it is rapidly developed in recent years, in particular, in the field of air conditioner refrigeration. However, since a lithium bromide refrigeration machine set includes a large number of big components, the entire machine set occupies a large volume, which is relatively heavy and inconvenient. With this regard, it needs to be improved.

### SUMMARY

The present disclosure aims at solving at least one of technical problems existing in the prior art. With this regard, the present disclosure provides a miniaturized lithium bromide refrigeration system with a simplified structure.

A lithium bromide refrigeration system according to embodiments of the present disclosure includes: a generator having a liquid storage cavity, the generator being connected to a heating apparatus, and an upper end of the generator being provided with an exhaust pipe; an absorber having an inner cavity, the absorber being provided with a cooling mechanism located at a lower part of the inner cavity; an evaporator located above the absorber, the evaporator having an evaporation chamber communicated with the inner cavity, the evaporator being connected to a water inlet pipe for introducing water into the evaporation chamber, and the evaporator being connected to a blowing apparatus; a vacuum pump connected to the absorber, the vacuum pump being configured for vacuumizing the inner cavity. The generator is provided with a spraying pipe communicated with the liquid storage cavity; an outlet of the spraying pipe is located at an upper part of the inner cavity; the absorber is provided with a liquid extraction pipe communicated with the inner cavity; and an outlet of the liquid extraction pipe is located at an upper part of the liquid storage cavity. The system further includes a heat exchanger for exchanging heat between the spraying pipe and the liquid extraction pipe.

The lithium bromide refrigeration system according to the embodiments of the present disclosure at least has the following beneficial effects. A mixed solution of lithium bromide and water is heated in the liquid storage cavity of the generator; water is evaporated into water vapor to be discharged from the exhaust pipe to obtain a strong lithium bromide solution. By means of the spraying pipe, the strong lithium bromide solution is introduced into the inner cavity of the absorber. As the evaporation chamber of the evaporator is communicated with the inner cavity and is vacuumized into vacuum by means of the vacuum pump, water entering the evaporation chamber by means of the water inlet pipe is rapidly evaporated into water vapor by absorbing heat, thereby a cooled air can be prepared for indoor refrigeration. The water vapor in the evaporation chamber is absorbed by the strong lithium bromide solution in the inner cavity while the strong lithium bromide solution in the inner cavity absorbs the water vapor and becomes the mixed solution of lithium bromide and water, and then is transmitted to the generator by means of the liquid extraction pipe for heating and water removal. The above process is circulated to implement continuous refrigeration. As compared with conventional lithium bromide refrigeration devices, a condenser is omitted, thus simplifying the structure, reducing the device size, and facilitating miniaturization.

According to some embodiments of the present disclosure, the water inlet pipe is connected to a running water pipe.

According to some embodiments of the present disclosure, an outlet of the exhaust pipe is configured to face the liquid extraction pipe.

According to some embodiments of the present disclosure, the liquid extraction pipe is configured to at least partially pass through the exhaust pipe.

According to some embodiments of the present disclosure, the system further includes a water reservoir for collecting water condensed from a surface of the liquid extraction pipe.

According to some embodiments of the present disclosure, the water inlet pipe is provided with a gas and liquid separator.

According to some embodiments of the present disclosure, an outlet of the water inlet pipe is provided with a spraying nozzle.

According to some embodiments of the present disclosure, a bottom of the generator is higher than the absorber, and the liquid extraction pipe is provided with a water pump.

According to some embodiments of the present disclosure, the cooling mechanism includes a coil located at a lower part of the inner cavity for cooling water to flow.

According to some embodiments of the present disclosure, the heating apparatus is a biomass burner.

Additional aspects and advantages of the present disclosure will be given in the following description, some of which will become apparent from the following description or may be learned from practices of the present disclosure.

### BRIEF DESCRIPTION OF THE DRAWINGS

The foregoing and/or additional aspects and advantages of the present disclosure will become apparent and comprehensible from the description of embodiments made with reference to the following accompanying drawings, wherein:

FIG. 1 is a schematic structural diagram of a lithium bromide refrigeration system according to some embodiments of the present disclosure.

### DETAILED DESCRIPTION

The embodiments of the present disclosure are described below in detail. Examples of the embodiments are shown in the accompanying drawings, and same or similar reference signs in all the accompanying drawings indicate same or similar components or components having same or similar functions. The embodiments described below with reference to the accompanying drawings are exemplary, and are only intended to explain the present disclosure and cannot be construed as a limitation to the present disclosure.

In the description of the present disclosure, it should be understood that, for orientation descriptions, orientations or state relationships indicated by terms such as up, down, front, rear, left, and right, are orientations or state relationships shown based on the accompanying drawings, and are used only for ease of describing the present disclosure and simplifying the description, rather than indicating or implying that the apparatus or element should have a particular orientation or be constructed and operated in a particular orientation, and therefore, should not be construed as a limitation on the present disclosure.

In the description of the present disclosure, the description of first and second are used merely for the purpose of distinguishing the technical features, and shall not be understood as indicating or implying relative importance or implying a quantity of indicated technical features or implying a precedence relationship of the indicated technical features.

In the description of the disclosure, unless otherwise clearly defined, terms such as “arrange”, “mount”, “connect” should be understood in a broad sense, and those skilled in the art can reasonably determine the specific meanings of the above terms in the disclosure by combining the specific contents of the technical solutions.

During lithium bromide absorption type refrigeration, since the lithium bromide aqueous solution itself has a relatively high boiling point (1265° C.), which is extremely hard to be volatilized, it can be considered that the vapor over a liquid surface of a lithium bromide saturated solution is pure water vapor. At a certain temperature, a saturation partial pressure of the water vapor over the liquid surface of the lithium bromide aqueous solution is smaller than that of pure water. Moreover, the higher the concentration, the smaller the saturation partial pressure of the water vapor over the liquid surface. Hence, under the same temperature condition, the higher the concentration of the lithium bromide aqueous solution, the stronger the capability of absorbing water content thereof. That is the reason that lithium bromide is often used as an absorbent and water is used as a refrigerant. A conventional lithium bromide absorption type refrigeration machine mainly includes a generator, a condenser, an evaporator, an absorber, a heat exchanger, and a circulation pump, the structure thereof is multifarious and disorderly, the volume thereof is large, and it is relatively heavy and inconvenient. During the operating process of the lithium bromide absorption type refrigeration machine, when the lithium bromide aqueous solution is heated in the generator, water in the solution is continuously gasified. As the water in the solution is continuously gasified, the concentration of the lithium bromide aqueous solution in the generator is continuously increased, and it enters the absorber. Water vapor enters the condenser, and is condensed after its temperature is decreased to become liquid water with high pressure and low temperature. When the water in the condenser enters the evaporator through a throttle, it is rapidly expanded to be gasified and absorbs a large amount of heat of refrigerant in the evaporator during the gasifying process, so as to achieve the purpose of temperature lowering and refrigeration. During this process, the low-temperature water vapor enters the absorber and is absorbed by the strong lithium bromide solution in the absorber, the concentration of the solution is gradually reduced, and is then sent back to the generator by the circulation pump, to complete the entire circulation. Such a circulation continues to continuously prepare refrigerating capacity.

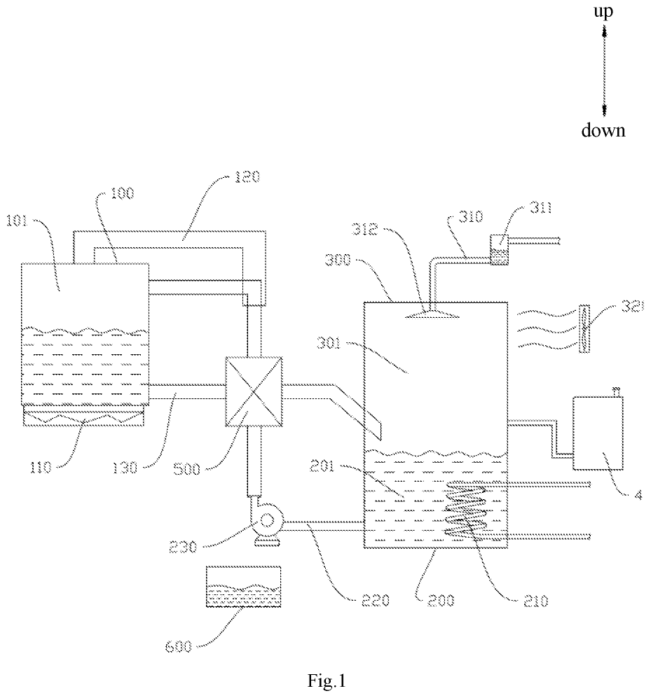

Referring to FIG. 1, some embodiments of the present disclosure provide a lithium bromide refrigeration system, including: a generator 100 having a liquid storage cavity 101, the generator 100 being connected to a heating apparatus 110, and an upper end of the generator 100 being provided with an exhaust pipe 120; an absorber 200 having an inner cavity 201, the absorber 200 being provided with a cooling mechanism 210 located at a lower part of the inner cavity 201; an evaporator 300 located above the absorber 200 and having an evaporation chamber 301 communicated with the inner cavity 201, where it can be understood that the absorber 200 and the evaporator 300 may be integrally designed; the evaporator 300 being connected to a water inlet pipe 310 for introducing water into the evaporation chamber 301; a vacuum pump 400 connected to the absorber 200, the vacuum pump 400 being configured for vacuumizing the inner cavity 201; where the generator 100 is provided with a spraying pipe 130 communicated with the liquid storage cavity 101; an outlet of the spraying pipe 130 is located at an upper part of the inner cavity 201; the absorber 200 is provided with a liquid extraction pipe 220 communicated with the inner cavity 201; and an outlet of the liquid extraction pipe 220 is located at an upper part of the liquid storage cavity 101; and a heat exchanger 500 for exchanging heat between the spraying pipe 130 and the liquid extraction pipe 220.

The lithium bromide refrigeration system operates smoothly as follows. A mixed solution of lithium bromide and water is heated in the liquid storage cavity 101 of the generator 100, and water is evaporated by heating into water vapor and then is discharged from the exhaust pipe 120 to obtain the strong lithium bromide solution. By means of the spraying pipe 130, the strong lithium bromide solution is introduced into the inner cavity 201 of the absorber 200, and its temperature is lowered by the cooling mechanism 210, thereby improving the capability of absorbing the water vapor. As the evaporation chamber 301 of the evaporator 300 is communicated with the inner cavity 201 and is vacuumized by the vacuum pump 400, water entering the evaporation chamber 301 from the water inlet pipe 310 is rapidly evaporated into the water vapor (water would evaporated at 4° C. in a lower pressure environment close to vacuum).The water absorbs heat during the rapid evaporation. The cooled air may be drawn by the blowing apparatus 320 for indoor refrigeration. Alternatively, the cooled water may be drawn and then transmitted to each room for preparing the cooled air (the central air-conditioning mode). The water vapor in the evaporation chamber 301 is absorbed by the strong lithium bromide solution in the inner cavity 201, and the strong lithium bromide solution in the inner cavity 201 turns into the mixed solution of lithium bromide and water after absorbing the water vapor. The mixed solution of lithium bromide and water is further transmitted to the generator 100 by means of the liquid extraction pipe 220 to remove water by heating. The above process is circulated to implement continuous refrigeration. As compared with conventional lithium bromide refrigeration devices, a condenser is omitted, thus simplifying the structure, reducing the device size, and facilitating miniaturization. Since the temperature of the strong lithium bromide solution in the liquid extraction pipe 220 is relatively low while the temperature of the mixed solution of lithium bromide and water in the spraying pipe 130 is relatively high, the heat exchanger 500 is provided for exchanging heat, to improve the temperature of the mixed solution of lithium bromide and water entering the generator 100, reduce the heating requirement, and save energy.

Referring to FIG. 1, according to some embodiments of the present disclosure, the water inlet pipe 310 is connected to a running water pipe to be directly supplied with the running water without additional power. Upon measurement, the refrigerating capacity at 1 kw for 1 hour only needs 3.6 kg of water.

According to some embodiments of the present disclosure, an outlet of the exhaust pipe 120 is configured to face the liquid extraction pipe 220. Hence, the water vapor sprayed by the exhaust pipe 120 contacts the liquid extraction pipe 220 for heat exchange, so as to improve the temperature of the mixed solution of lithium bromide and water in the liquid extraction pipe 220, facilitating energy saving.

Referring to FIG. 1, according to some other embodiments of the present disclosure, the liquid extraction pipe 220 is configured to partially pass through the exhaust pipe 120 and thus the water vapor in the exhaust pipe 120 surrounds a part of the liquid extraction pipe 220, so as to improve the temperature of the mixed solution of lithium bromide and water in the liquid extraction pipe 220, facilitating energy saving.

Referring to FIG. 1, according to some embodiments of the present disclosure, the system further includes a water reservoir 600 for collecting water condensed from a surface of the liquid extraction pipe 220, so as to prevent condensate water from flowing outwards to influence other devices on one hand, and to collect the condensate water to save water resources on the other hand.

Referring to FIG. 1, according to some embodiments of the present disclosure, the water inlet pipe 310 is provided with a gas and liquid separator 311 for removing the air in the running water, avoiding the influence on the vacuum degree of the evaporation chamber 301. As can be understood, the water inlet pipe 310 is further provided with an open and close valve and a filter screen, which may be closed at any time.

Referring to FIG. 1, according to some embodiments of the present disclosure, an outlet of the water inlet pipe 310 is provided with a spraying nozzle 312. Using the spraying nozzle 312 can effectively dispersing water, accelerating the rapid evaporation of water, and facilitating to improve the refrigeration efficiency.

Referring to FIG. 1, according to some embodiments of the present disclosure, the bottom of the generator 100 is higher than the absorber 200, and the liquid extraction pipe 220 is provided with a water pump 230. As can be understood, as the generator 100 is located at a high position, the strong lithium bromide solution in the liquid storage cavity 101 of the generator 100 can automatically flow into the inner cavity 201 of the absorber 200 through the spraying pipe 130. The absorber 200 is located at a low position, and therefore, the water pump 230 is added to transmit the mixed solution of lithium bromide and water in the inner cavity 201 of the absorber 200 into the liquid storage cavity 101 of the generator 100.

Referring to FIG. 1, according to some embodiments of the present disclosure, the cooling mechanism 210 includes a coil located at a lower part of the inner cavity 201 for cooling water to flow. As can be understood, the cooling mechanism 210 is connected to a cooling tower to lower the temperature of the cooling water, and ensure that the cooling water can effectively lower the temperature of the strong lithium bromide solution in the absorber 200.

Referring to FIG. 1, according to some embodiments of the present disclosure, the heating apparatus 110 is a biomass burner. The generator 100 is heated by means of the heat generated by burning. Since the generator 100 requires a temperature of only about 75° C., the biomass burner is sufficient to meet the requirement, which is more environmentally friendly. Certainly, a gas furnace, an electric heating furnace, and the like may also be adopted for heating.

The embodiments of the present disclosure are explained in detail by combining the accompanying drawings above. However, the present disclosure is not limited to the embodiments above; within the range of knowledge mastered by a person having ordinary skill in the art, various changes may be made under the premise of not departing from purposes of the present disclosure.

What is claimed is:

1. A lithium bromide refrigeration system, comprising:
a generator having a liquid storage cavity, the generator being connected to a heating apparatus, and an upper end of the generator being provided with an exhaust pipe;
an absorber having an inner cavity, the absorber being provided with a cooling mechanism located at a lower part of the inner cavity;
an evaporator located above the absorber, the evaporator having an evaporation chamber communicated with the inner cavity, the evaporator being connected to a water inlet pipe for introducing water into the evaporation chamber;
a vacuum pump connected to the absorber, the vacuum pump being configured for vacuumizing the inner cavity;
wherein the generator is provided with a spraying pipe communicated with the liquid storage cavity; an outlet of the spraying pipe is located at an upper part of the inner cavity; the absorber is provided with a liquid extraction pipe communicated with the inner cavity; an outlet of the liquid extraction pipe is located at an upper part of the liquid storage cavity; and the system further comprises a heat exchanger for exchanging heat between the spraying pipe and the liquid extraction pipe.

2. The lithium bromide refrigeration system of claim 1, wherein the water inlet pipe is connected to a running water pipe.

3. The lithium bromide refrigeration system of claim 1, wherein an outlet of the exhaust pipe is configured to face the liquid extraction pipe.

4. The lithium bromide refrigeration system of claim 1, wherein the liquid extraction pipe is configured to at least partially pass through the exhaust pipe.

5. The lithium bromide refrigeration system of claim 3, further comprising a water reservoir for collecting water condensed from a surface of the liquid extraction pipe.

6. The lithium bromide refrigeration system of claim 1, wherein the water inlet pipe is provided with a gas and liquid separator.

7. The lithium bromide refrigeration system of claim 6, wherein an outlet of the water inlet pipe is provided with a spraying nozzle.

8. The lithium bromide refrigeration system of claim 1, wherein a bottom of the generator is higher than the absorber, and the liquid extraction pipe is provided with a water pump.

9. The lithium bromide refrigeration system of claim 1, wherein the cooling mechanism comprises a coil located at a lower part of the inner cavity for cooling water to flow.

10. The lithium bromide refrigeration system of claim 1, wherein the heating apparatus is a biomass burner.
